(19) United States
(12) Patent Application Publication
(10) Pub. No.: US 2018/0171622 A1
(43) Pub. Date: Jun. 21, 2018

(54) REMOTE COMMAND AND CONTROL CENTER FOR LONGWALL MINING SYSTEM

(71) Applicant: ALLIANCE COAL, LLC, LEXINGTON, KY (US)

(72) Inventor: ROB COLAW, SAINT CLAIRSVILLE, OH (US)

(73) Assignee: ALLIANCE COAL, LLC, LEXINGTON, KY (US)

(21) Appl. No.: 15/385,440

(22) Filed: Dec. 20, 2016

(51) Int. Cl. E04B 1/343; F24F 13/28; F24F 7/00; B60H 1/00; E04B 1/348; E04B 1/92; E04H 5/02; E21F 11/00

(52) U.S. Cl. CPC E04B 1/34336; F24F 13/28; F24F 7/00; B60H 1/00364; E04B 1/34815; E21C 27/02; E04B 1/92; E04H 5/02; E21F 11/00; E04B 2001/34394; E04B 1/34305

(57) ABSTRACT

A remote command and control center for a longwall mining system that can be located away from the longwall face and belt line components such as the cutter, conveyor and roof supports is provided. The command and control center is comprised of two nested halves which allow for the height of the command and control module to be quickly and easily adjusted to allow the remote command and control module to be introduced into areas where clearance is an issue. The command and control center can be pressurized to push coal dust and other contaminants out of the command and control center to protect the operators from inhaling hazardous coal dust. A rack system for mounting video monitors within the command and control module is also provided.

### BACKGROUND OF THE INVENTION

### Field of the Invention

The present invention relates to a control and command center for use in underground mining operations. More specifically, the present invention relates to a control and command center for underground long wall mining systems that allows the mining operation to be controlled from a remote location.

### Description of the Related Art

Longwall mining is a highly productive underground coal mining method where a long wall of coal is mined in a single slice, typically of thickness 0.6 m to 1.0 m. The longwall face (the block of coal that is being mined) may be up to 1,200 feet long and up to 15,000 feet wide. In long wall mining, a cutting machine is trammed across the face (longwall) of the coal seam. The cutting machine can be either a revolving cylinder with bits that shear off the coal or a plow that forcefully shaves the coal from the face. In either case, the mining machine cuts or shaves blocks or panels of coal from the mine wall in a back-and-forth motion, similar to that of a meat slicer. The removed and broken coal is then dumped onto a conveyor belt that extends across much of the mine which carries it out of the mine. Hydraulic roof supports are used to support the coal and earth above the mining operation. The roof supports are typically large steel supports, attached to the longwall machine that can be moved with the mining operation. As the machine moves forward, the roof supports are advanced providing protection to the miners and equipment. As the mining machine advances, the roof behind it caves in i.e. the roof behind the supports is allowed to fall into an area known as the gob.

In order for all of these components to operate efficiently and safely, complex controls systems must be utilized. A command and control center integrating sensors and controls for monitoring the equipment and mine conditions must be used to ensure that the coal is removed safely and efficiently. One system currently in use includes a wireless remote that is used by an operator at the face to operate the shear and a separate master control located at the stage loader for starting and stopping the conveyor. While the types of command and control modules in use attempt to minimize the operator's exposure to dust, noise and the hazards associated with heavy moving machinery, the operators are still exposed to significant health and safety hazards because the command and control center is still located in the area of the face that is being mined.

Accordingly, there is a need for a command and control module that improves safety by removing the worker who is controlling the shear from the face. There is further a need for a command and control system that further minimizes the operator's exposure to coal dust. There is also a need for a single command and control center that combines control of the shear and the conveyor in a single remote location. A further need is to provide a remote command and control module that can be quickly and easily modified to permit them to be introduced into mines of varying ceiling heights where clearance is an issue, and that can be quickly and easily set up one it is in position.

### SUMMARY OF THE INVENTION

It is therefore an object of the present invention to provide a command and control center for a longwall mining system that removes the operator from the area of the belt line and mining face to a remote location free from the hazards of the moving parts associated with the longwall face and equipment.

It is also an object of the invention to provide an enclosed command and control center for a longwall mining system that effectively shields the operator from exposure to coal dust. It is yet a further object of the invention to provide a command and control center for a longwall mining system that can be collapsed to allow the command and control center to be introduced into the underground mine where ceiling clearance can be an issue, while providing a command and control center that can be set up quickly and easily.

The present invention meets these objects by providing a remote command and control center for a longwall mining system that can be located away from the longwall face and belt line components such as the cutter, conveyor and roof supports, thus minimizing the operator's exposure to these hazaradous components of the system. The present invention also meets these requirements by providing a command and control center that is comprised of two nested halves which allow for the height of the command and control module to be quickly and easily adjusted to allow the remote command and control module to be introduced into areas where clearance is an issue. Lastly, the present invention meets these requirement by providing a command and control center that can be pressurized to push coal dust and other contaminants out of the command and control center to protect the operators from inhaling hazardous coal dust.

According to one presently preferred embodiment of the invention, there is provide a remote command and control center for a longwall mining machine comprising an enclosure having a floor connected to a ceiling by at least one sidewall; means for adjusting the height of the enclosure by varying the distance between the floor and the ceiling of the enclosure; means for creating positive air pressure within said enclosure; visual display means located within said enclosure for displaying data and/or images from a remotely located longwall mining machine; and control means located within said enclosure for controlling the operation of the remotely located long wall mining machine.

The enclosure of the remote command and control center according to one aspect of the invention may include a first shell housing member having an end wall and at least one side wall extending therefrom to form an opening at a free end of the at least one sidewall, and a second shell housing member having an end wall and at least one side wall extending therefrom to form an opening at a free end of the at least one sidewall. The second shell housing member is configured to nest within said first housing member such that the end wall of the first shell housing member, the end wall of said second housing member and side walls of the first and second housing members form an enclosed space.

The height adjusting means of the remote command and control center according to one aspect of the invention may comprise a jack lift system affixed to the first shell housing and affixed to the second shell housing for affecting relative movement therebetween. The jack lift system may include a motor driving a primary gear box. The primary gear box may be connected to a plurality of worm gear screw jacks.

The means for creating positive air pressure within the enclosure may include an air handling unit affixed to the enclosure for transferring air from the outside to the interior of the enclosure. The air handling unit may further include a filter for filtering the air as it is transferred from the outside to the inside.

The visual display means of the remote command and control center according to one aspect of the invention may include one or more video monitors removably attached to a rail system, affixed to the ceiling of the enclosure. The rail system may include a plurality of vertical rail members extending downwardly from the ceiling and one or more horizontal rail members moveably affixed to the plurality of vertical rail members. The one or more video monitors are removably attached to the one or more horizontal rail members. The one or more horizontal rail members may be adjustable relative to the vertical rail members.

The remote command and control center may further include a movable desktop positioned within the enclosure. The movable desktop may be slidably affixed at a first end and at a second end to the at least one sidewall. The enclosure of the remote command and control center may be positioned on a lowboy trailer according to a further aspect of the invention.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1A is a side view in elevation of the remote command and control center for longwall mining system according to a preferred embodiment of the present invention, with the command and control center shown in the collapsed or transport state.

FIG. 1B is a side view in elevation of the remote command and control center for longwall mining system according to a preferred embodiment of the present invention, with the command and control center shown in the expanded or operational state.

FIG. 2 is an end view in elevation of the remote command and control center for longwall mining system shown in FIG. 1B.

FIG. 3 is a perspective view of the mechanical lift system for the remote command and control center for long wall mining system according to one preferred embodiment of the present invention.

FIG. 4A is a perspective sectional view of the remote command and control center for longwall mining system according to a preferred embodiment of the present invention, with the command and control center shown in the collapsed or transport state and showing the interior of the command and control center.

FIG. 4B is a perspective sectional view of the remote command and control center for longwall mining system according to a preferred embodiment of the present invention, with the command and control center shown in a partially expanded operational state and showing the interior of the command and control center.

FIG. 4C is a perspective sectional view of the remote command and control center for longwall mining system according to a preferred embodiment of the present invention, with the command and control center shown in a fully expanded operational state and showing the interior of the command and control center.

FIG. 4D is a perspective sectional view of the remote command and control center for longwall mining system according to a preferred embodiment of the present invention, with the command and control center shown in the fully expanded operational state and showing an alternate configuration of the interior of the command and control center.

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

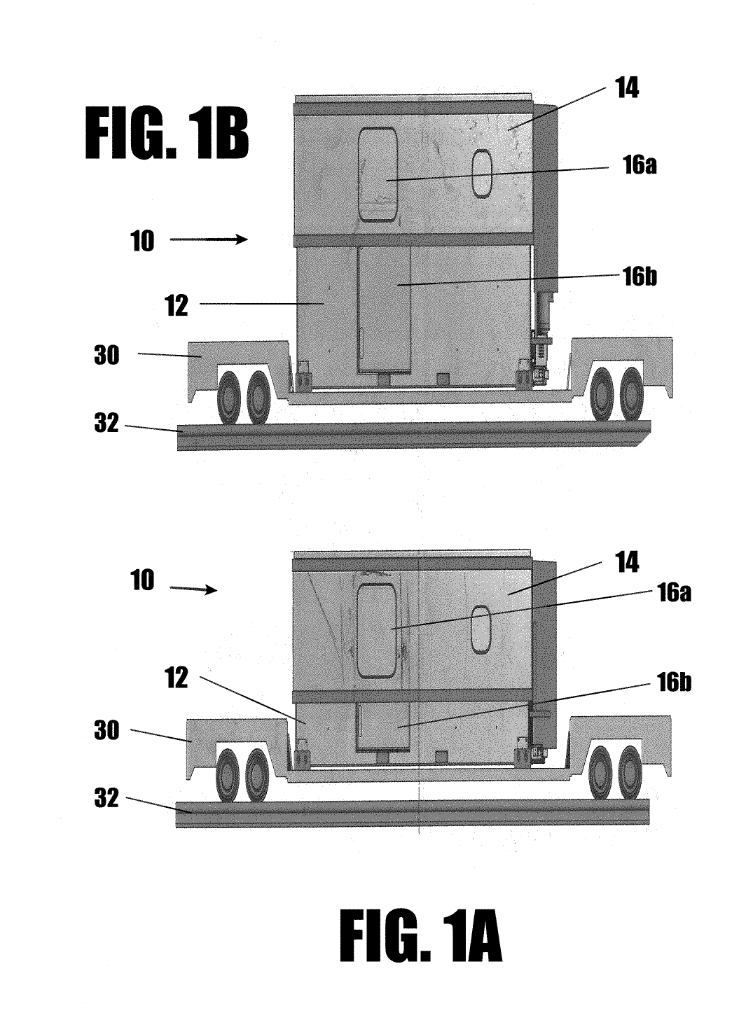

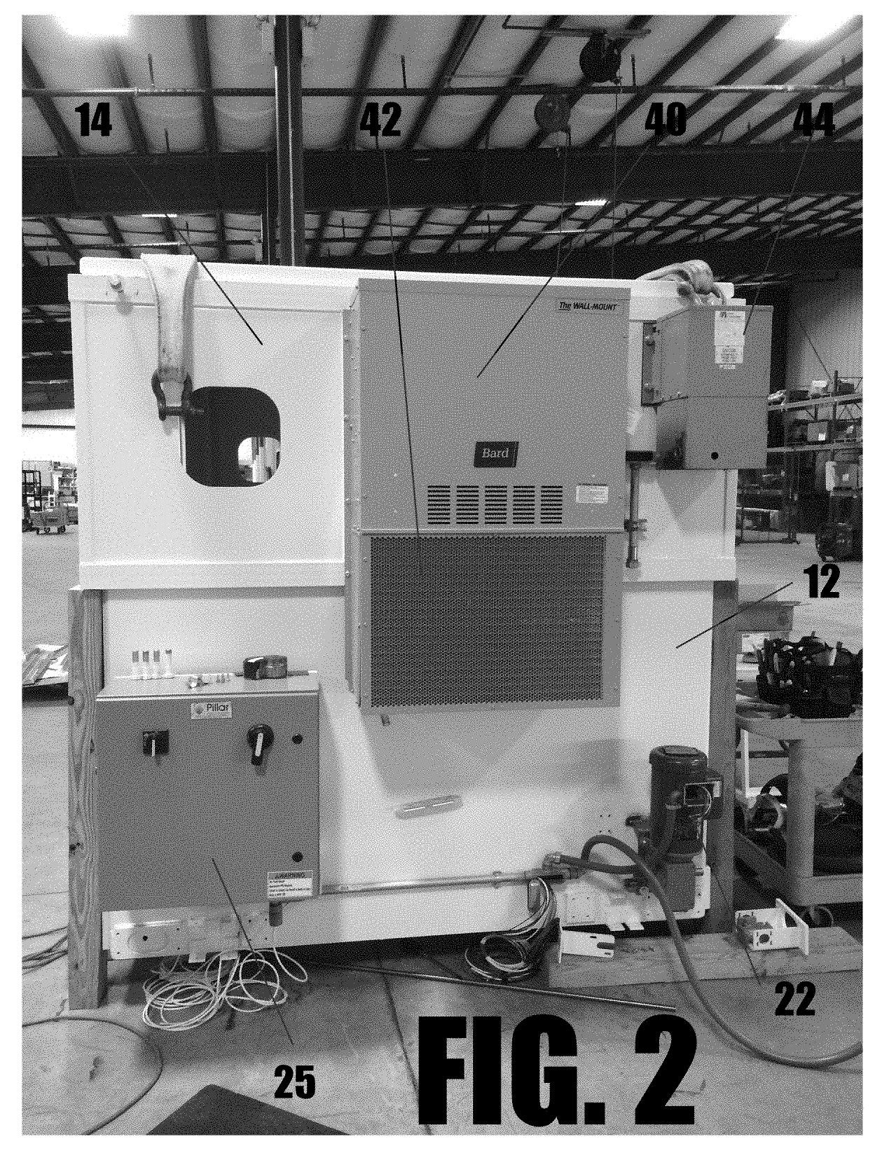

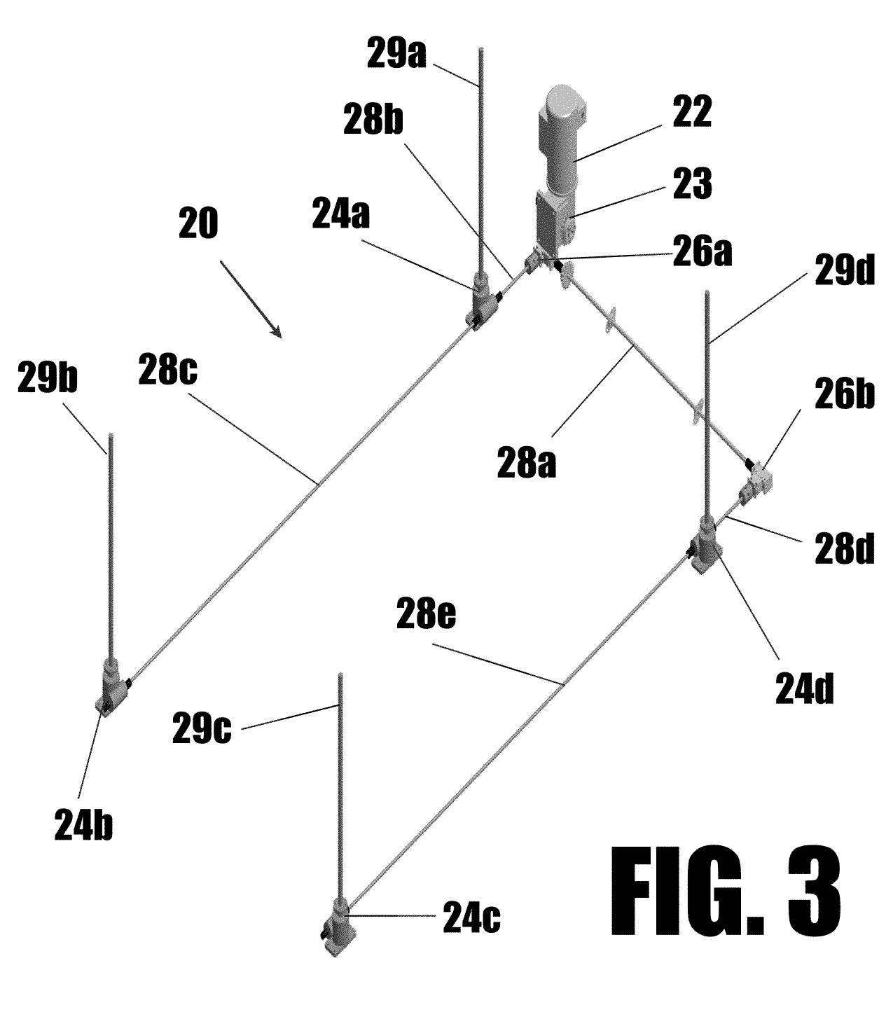

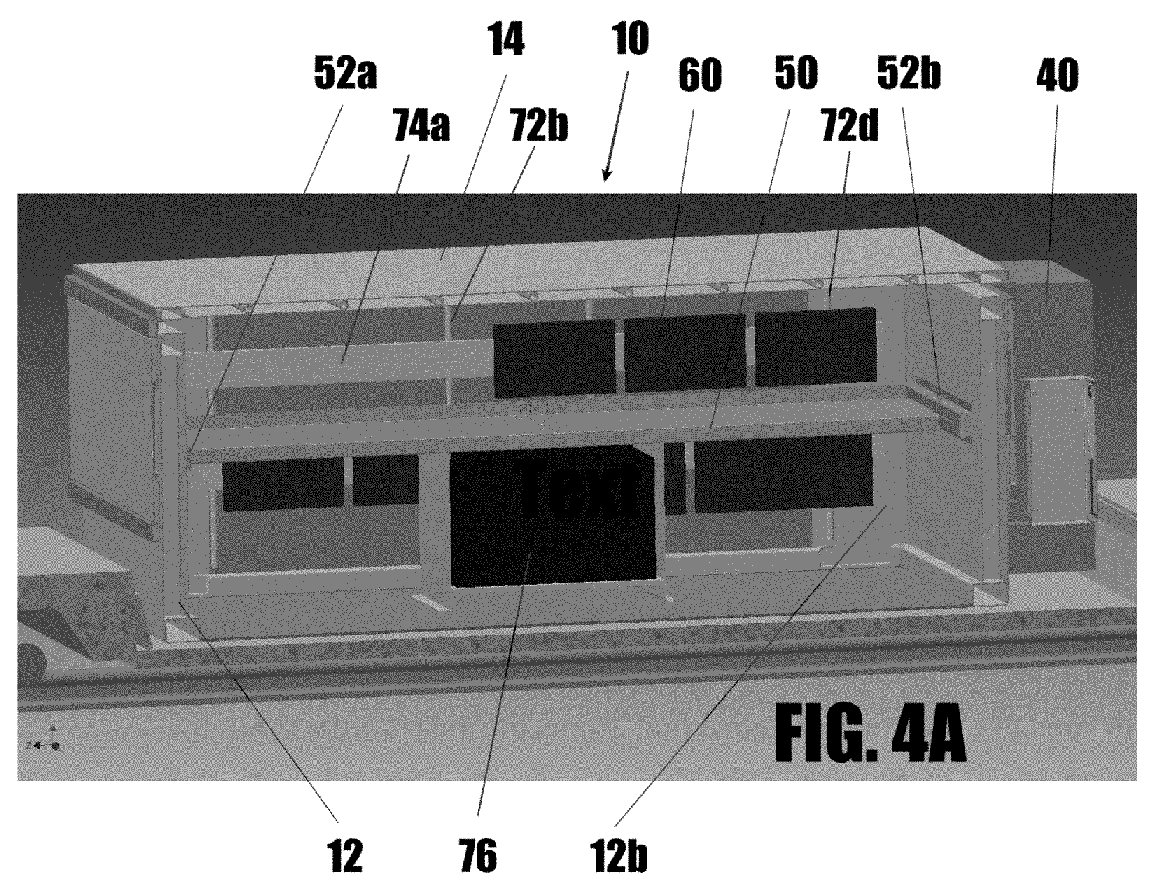

As best shown in FIG. 1A and FIG. 1B, one presently preferred embodiment of the invention comprises a remote command and control center 10 for a longwall mining system comprising a lower shell member 12 and an upper shell member 14. The lower shell member 12 according to the preferred embodiment is configured to nest within the upper shell member 14 when the remote command and control center 10 is in the collapsed or transport mode as shown in FIG. 1A. The remote command and control center 10 is transformed from the collapsed or transport mode shown in FIG. 1A to the expanded or operational mode shown in FIG. 1B by a lift system 20, which is best shown in FIG. 3.

The lift system shown in FIG. 3 according to one presently preferred embodiment of the invention is a U configuration screw jack lift system 20 that includes a motor 22 driving a primary gear box 23 which is connected to four worm gear screw jacks 24a, 24b, 24c, 24d via a pair or right angle bevel gear boxes 26a, 26b and linking bars 28a, 28b, 28c, 28d. A top plate is attached to the upper shell member 14 and the upper end of each of the vertical lifting screws 29a, 29b, 29c, 29d of the screw jack lift system 20 to raise and lower the upper shell member 14 as the vertical lifting screws 29a, 29b, 29c, 29d are turned. An electrical control box 25 (FIG. 2) is electrically coupled to the motor 22 and supplies electrical power to the motor as determined by inputs from a user at the control box 25. Although the preferred embodiment shows a U configuration four jack lift system, other configurations that can accomplish the task of raising and lowering the upper shell are anticipated, including but not limited to hydraulic lift systems and other mechanical and electrical lift systems. Once the screw jack lift system 20 has been used to lift the upper shell 14 into the operating position shown in FIG. 1B, pins can be inserted to secure the upper shell 14 in place relative to the lower shell 12 for additional safety.

As shown in FIG. 1A and FIG. 1B, the remote command and control center 10 is preferably positioned on a drop deck low boy trailer 30 which can be used to move the command and control center 10 into and out of the mine along rails 32. The upper shell member 14 and lower shell member 12 include door members 16a, 16b to permit access to the interior of the command and control center 10. When the remote command and control center 10 is in the fully extended position shown in FIG. 1B, the height of the top of the upper shell 14 is preferably 84 inches above the mine floor.

Exposure to coal dust in an underground longwall mine presents both a hazard to workers and to sensitive electronics. Accordingly the remote command and control center 10 is provided with seals at joints thereof to prevent dirty air from entering inside. Specifically, a seal extends around the periphery of the command and control center where the upper half 14 and lower half 12 meet. The space between the door members 16a, 16b and the door jambs are also provided with seals to prevent the incursion of dirty air to the interior of the command and control center 10. An air handler unit 40 is preferably mounted on the upper half 14 of the command and control center 10. The air handler unit 40 includes a blower and filters 42. The air handler unit, through blower and filters 42 provides filtered air to the interior of the command and control center 10. The air handler unit 40 in conjunction with the aforementioned seals creates a pressurized chamber within the lower shell 12 and upper shell 14 thereby pushing any dust that gets inside the command and control center out. Thus, the command and control center 10 is fully enclosed and pressurized thereby providing a clean, safe environment for both the operators and the equipment located therein. A main electrical box 44 is also provided to connect the command and control center 10 to an external power source.

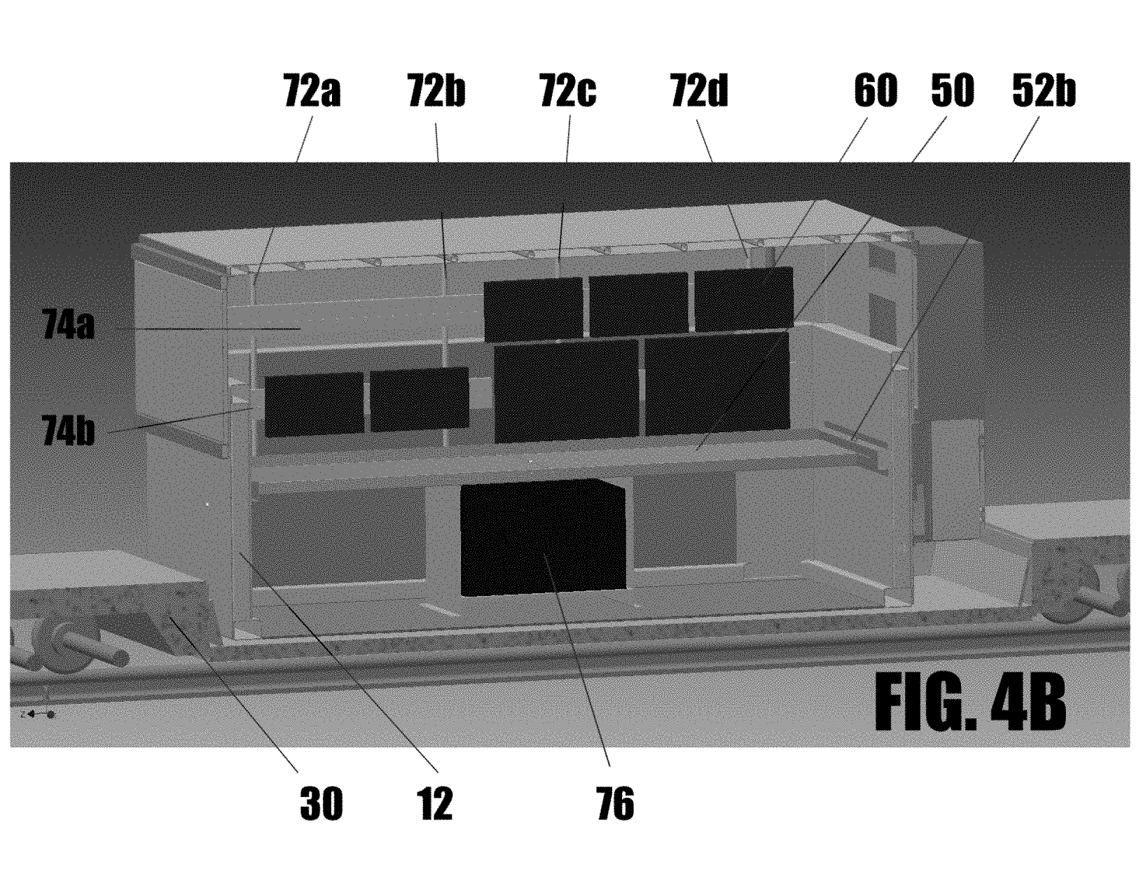

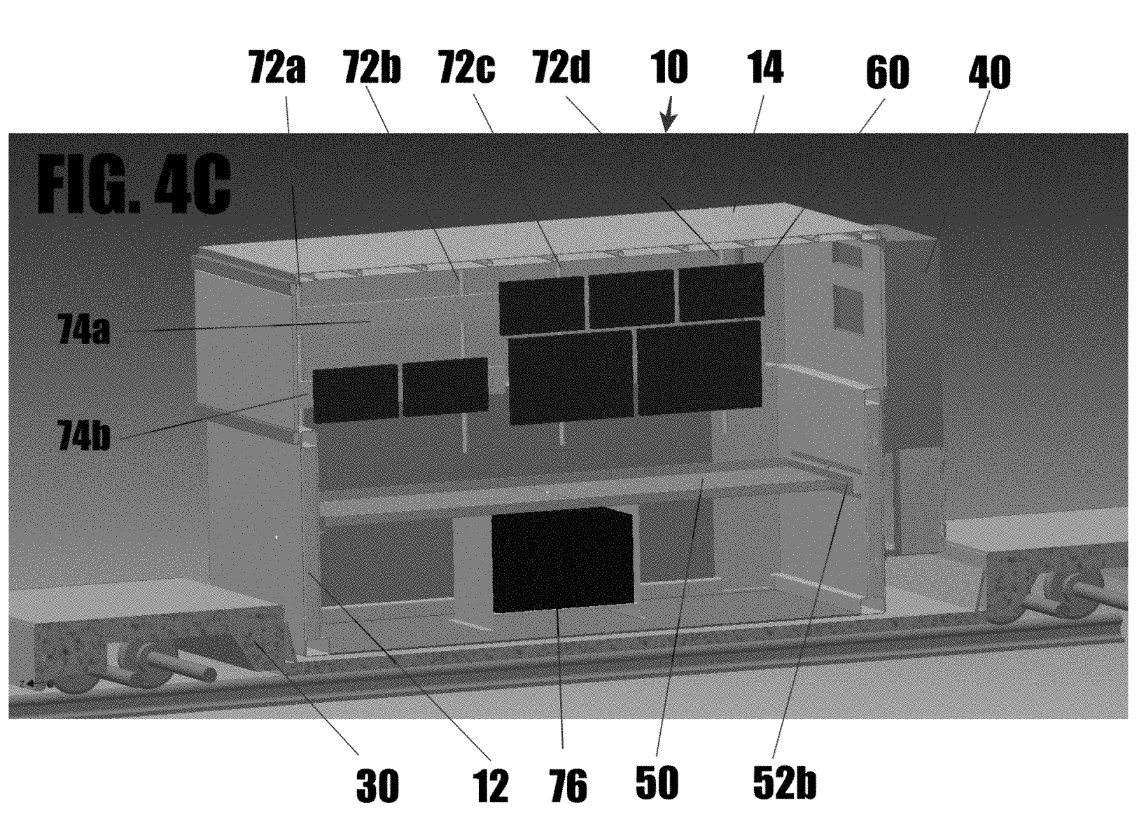

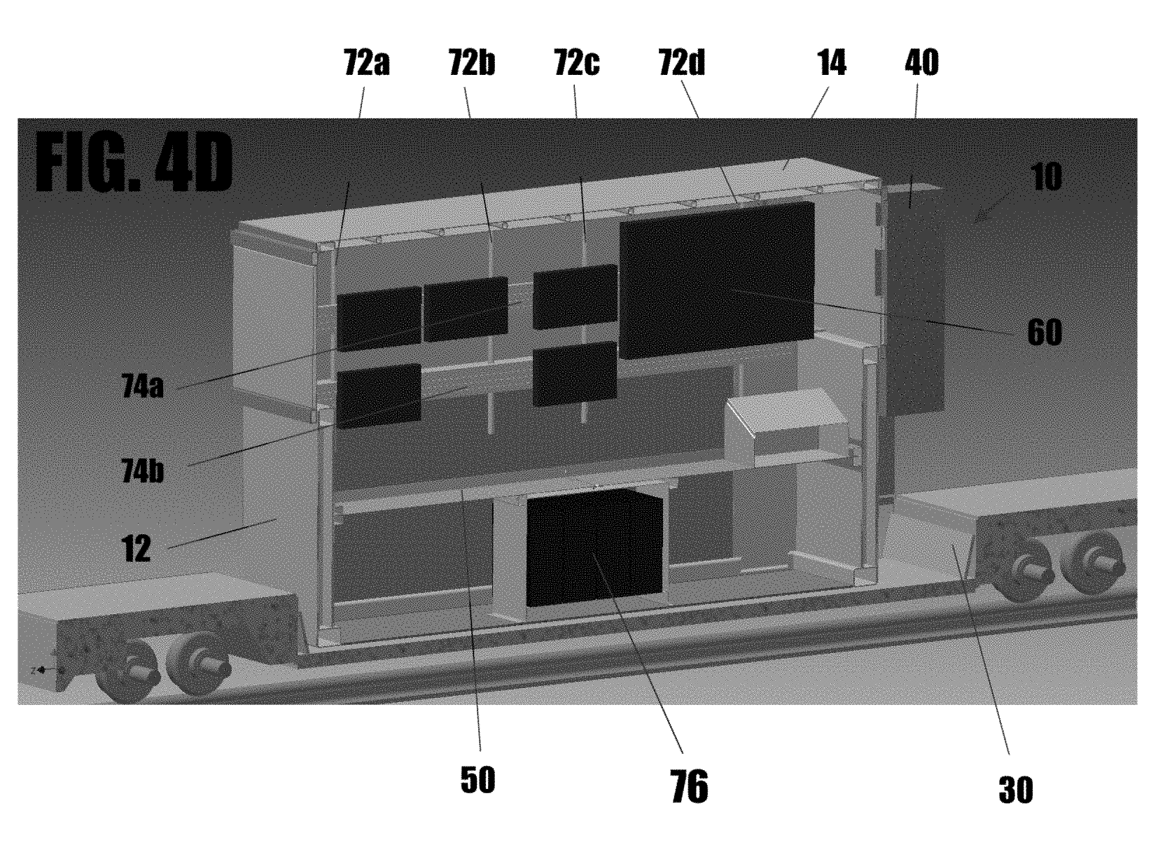

The interior features of the remote command and control center 10 according to a preferred embodiment of the invention are shown in FIG. 4A, FIG. 4B, and FIG. 4C. A desktop or work surface 50 is provided for one or more workers stationed inside. Each end of the work surface 50 is located in a slide mechanism 52a, 52b. The slide mechanisms 52a, 52b allow the work surface to be moved or slid away from the back wall 12b of the lower shell 12 thereby permitting monitors 60 hanging on rails 62 on the back wall 14b of the upper shell to be lowered behind the work surface 50 when the command and control center 10 is in the transport mode as shown in FIG. 4A. A limit switch may be used to ensure that the work surface 50 is in the transport position before the upper shell 14 is lowered into the transport position shown in FIG. 4A.

The monitors 60 are secured in place by a rail systems 70, which includes vertical rails 72a, 72b, 72c, 72d which have an upper end that is preferably mounted to the ceiling of the upper shell 14. Horizontal rail members 74a, 74b are movably secured to the vertical rails 72a, 72b, 72c, 72d by pinch bolts or other suitable fasteners on the rear surface thereof. The use of pinch bolts allow the positions of the horizontal rail members 74a, 74b to be adjusted along the longitudinal axes of the vertical rail members 72a, 72b, 72c, 72d, thus permitting different configurations of monitors as shown in FIG. 4D. A control module 76 is located under the desktop 50. The control module 76, video monitors 60 and electrical and/or communication outlets for other portable communication and control devices such as laptop computers, telephones and the like is electrically connected to the main electrical control box 44 which is connected to a power source and/or to the longwall mining machine.

When in use, the remote command and control center 10 is preferably set up in the fully extended position as shown in FIG. 4C and FIG. 4D. In this configuration, the top of the command and control center is preferably 84 inches above the mine floor. Where headspace is an issue, the remote command and control center 10 can be set up in an intermediate position as shown in FIG. 4B, which, according to the presently preferred embodiment is approximately 72 inches tall.

In operation, cameras can be strategically positioned on the longwall mining machine (shear or plow) at the face of the coal to be mined. The video from the cameras can then be transmitted to the monitors 60 in the remote command and control center 10, thereby removing the controllers from the mine face. The present invention removes the operators from the face of the mine near the plow or shear and relocates them to the secure environment of the command and control center. By removing the operators from the face, they are not exposed to the dust and dangerous moving parts of the longwall mining machine.

The detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

1. A remote command and control center for a longwall mining machine comprising:
an enclosure having a floor connected to a ceiling by at least one sidewall;
means for adjusting the height of the enclosure by varying the distance between the floor and the ceiling of the enclosure;
means for creating positive air pressure within said enclosure;
visual display means located within said enclosure for displaying data and/or images from a remotely located longwall mining machine;
control means located within said enclosure for controlling the operation of the remotely located long wall mining machine.

2. The remote command and control center according to claim 1 wherein the enclosure comprises:
a first shell housing member having an end wall and at least one side wall extending therefrom to form an opening at a free end of the at least one sidewall;
a second shell housing member having an end wall and at least one side wall extending therefrom to form an opening at a free end of the at least one sidewall, said second shell housing member configured to nest within said first shell housing member such that the end wall of the first shell housing member, the end wall of said second shell housing member and side walls of said first and second shell housing members form an enclosed space

3. The remote command and control center according to claim 2 wherein the height adjusting means comprises a jack lift system affixed to said first shell housing member and affixed to said second shell housing member for affecting relative movement therebetween.

4. The remote command and control center according to claim 3 wherein the jack lift system comprises a motor driving a primary gear box, said primary gear box connected to a plurality of worm gear screw jacks.

5. The remote command and control center according to claim 1 wherein said means for creating positive air pressure comprises an air handling unit affixed to the enclosure for transferring air from the outside to the interior of the enclosure.

6. The remote command and control center according to claim 5 wherein the air handling unit further comprising a filter for filtering the air as it is transferred from the outside to the inside.

7. The remote command and control center according to claim 1 wherein said visual display means comprises one or more video monitors removably attached to a rail system, affixed to the ceiling of the enclosure.

8. The remote command and control center according to claim 7 wherein the rail system comprises a plurality of vertical rail members extending downwardly from the ceiling and one or more horizontal rail members moveably affixed to said plurality of vertical rail members, said one or more video monitors being removably attached to said one or more horizontal rail members.

9. The remote command and control center according to claim 8 wherein the one or more horizontal rail members are adjustable relative to the plurality of vertical rail members.

10. The remote command and control center according to claim 7 further comprising a movable desktop positioned within the enclosure.

11. The remote command and control center according to claim 10 wherein said movable desktop is slidably affixed at a first end and at a second end to said at least one sidewall.

12. The remote command and control center according to claim 1 wherein the enclosure is positioned on a lowboy trailer.
